(19) United States
(12) Patent Application Publication
(10) Pub. No.: US 2026/0328637 A1
(43) Pub. Date: Oct. 22, 2026

(54) LEAK DETECTION USING A LENS TO DIVIDE ELECTROMAGNETIC RADIATION

(71) Applicant: Dell Products L.P., Round Rock, TX (US)

(72) Inventors: MICHAEL J. STUMPF, Cedar Park, TX (US); SANDOR TIBOR FARKAS, Round Rock, TX (US)

(21) Appl. No.: 19/184,559

(22) Filed: Apr. 21, 2025

(51) Int. Cl. G01M 3/20; G06F 1/20

(52) U.S. Cl. CPC G01M 3/20; G06F 1/20

(57) ABSTRACT

Devices, systems, and methods for managing leaks in a chassis of a data processing system is provided. To manage the leaks, the data processing system may include an electromagnetic stimulator, an electromagnetic detector, and a management component. The electromagnetic stimulator may be adapted to illuminate a sample area with electromagnetic radiation. The electromagnetic detector may be adapted to divide at least a portion of the electromagnetic radiation into a plurality of electromagnetic components, direct each of the plurality of the electromagnetic components to a corresponding sensor or a corresponding absorber to obtain a plurality of electromagnetic measurements, and estimate an electromagnetic spectrum based on the electromagnetic measurements. The management component may determine whether a liquid leak within the chassis occurred based on the electromagnetic spectrum. If the liquid leak occurred, performance of a remediation action may be initiated.

### FIELD

Embodiments disclosed herein relate generally to managing leaks. More particularly, embodiments disclosed herein relate to systems and methods for managing leaks in a chassis of a data processing system using a leak detector.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a data processing system in accordance with an embodiment.

FIG. 2 shows a diagram illustrating leak detection in accordance with an embodiment.

FIG. 3 shows a diagram illustrating an electromagnetic detector in accordance with an embodiment.

FIG. 4 shows a flow diagram illustrating a method for managing leaks in a chassis of a data processing system in accordance with an embodiment.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods, systems, and devices for managing operation of a data processing system. The data processing system may provide computer-implemented services. To provide the computer-implemented services, the data processing system may include any number and/or type of hardware components. Operation of the hardware components may facilitate various functionalities of the data processing system, thereby allowing the data processing system to provide the computer-implemented services.

However, operation of the hardware components may generate heat. To manage the heat generated by the hardware components so that the hardware components may operate as desired, a liquid cooling system may be used. To do so, a cooling liquid may be circulated within a chassis of the data processing system to dissipate at least a portion of the heat generated by the hardware components.

However, by circulating the cooling liquid through the chassis (and/or otherwise having liquid within the system), a likelihood of liquid damage may be increased within the system. For example, should the liquid cooling system leak at least a portion of the cooling liquid, the hardware components may be vulnerable to liquid damage. Consequently, such liquid damage may negatively impact the operation of the hardware components. In turn, this damage may also negatively impact the computer-implemented services provided by the data processing system.

To mitigate an impact of an occurrence of a liquid leak in the chassis of the data processing system, the data processing system may include functionality to detect leaks using a leak detector. The leak detector may be used to monitor portions of the data processing system which may have a risk of liquid leaks occurring (e.g., connection points of the cooling tubes). To do so, the leak detector may include: (i) an electromagnetic stimulator adapted to illuminate a sample area (e.g., in which the leak is likely to occur) with electromagnetic radiation, (ii) an electromagnetic detector, and/or (iii) a management component.

The electromagnetic detector may be adapted to divide at least a portion of the electromagnetic radiation into a plurality of electromagnetic components (e.g., based on colors/wavelengths of the electromagnetic components) using a lens. The lens may be adapted to cause the division of the electromagnetic radiation due to a lateral chromatic aberration of the lens. The lateral chromatic aberration may be facilitated by positioning the lens at an angle with respect to the at least the portion of the electromagnetic radiation.

Each of the plurality of the electromagnetic components may be directed to a corresponding sensor (e.g., portions of the plurality of the electromagnetic components which are to be measured) or a corresponding absorber (e.g., portions of the plurality of the electromagnetic components which are not to be measured). In doing so, a plurality of electromagnetic measurements usable to estimate an electromagnetic spectrum for the sample area may be obtained. Based on the electromagnetic spectrum, the management component may determine whether the liquid leak occurred. By identifying whether the liquid leak has occurred, remediation actions may be performed to reduce an impact of the liquid leak on operation of the data processing system.

Thus, embodiments disclosed herein may provide an improved data processing system that may have an improved likelihood of detecting a liquid leak within a chassis of the data processing system. By detecting the leak, additional leaked cooling liquid may be prevented from escaping into an interior of the chassis. Consequently, the hardware components may operate as desired, and computer-implemented services may be reliably provided by the data processing system using the hardware components.

In an embodiment, a data processing system is provided. The data processing system may include: a chassis; an electromagnetic stimulator adapted to illuminate a sample area with electromagnetic radiation; an electromagnetic detector adapted to: (i) divide at least a portion of the electromagnetic radiation into a plurality of electromagnetic components, (ii) direct each of the plurality of the electromagnetic components to a corresponding sensor or a corresponding absorber to obtain a plurality of electromagnetic measurements, (iii) estimate an electromagnetic spectrum based on the plurality of the electromagnetic measurements; and a management component adapted to: make a determination regarding whether a liquid leak within the chassis has occurred based on the electromagnetic spectrum; and in an instance of the determination where the liquid leak has occurred: initiate performance of a remediation action to mitigate impacts of the liquid leak.

The electromagnetic detector may include: (i) a lens adapted to divide the at least the portion of the electromagnetic radiation to obtain the plurality of the electromagnetic components; (ii) the corresponding sensor to make a first one of the plurality of the electromagnetic measurements; and (iii) the corresponding absorber adapted to absorb a one of the plurality of the electromagnetic components to reduce a likelihood that the one of the plurality of the electromagnetic components is erroneously detected by the corresponding sensor while making the first one of the plurality of the electromagnetic measurements.

The lens may include: (i) a first side through which the electromagnetic radiation enters the lens; and (ii) a second side through which the plurality of the electromagnetic components exits the lens.

The corresponding sensor and the corresponding absorber may be positioned with respect to the second side of the lens.

The lens may divide the at least the portion of the electromagnetic radiation based on wavelengths of the plurality of the electromagnetic components.

The lens may divide the at least the portion of the electromagnetic radiation due to a lateral chromatic aberration of the lens.

The lens may be positioned at an angle with respect to the electromagnetic radiation to generate the lateral chromatic aberration.

An ability of the electromagnetic detector to estimate the electromagnetic spectrum may be reduced when the one of the plurality of the electromagnetic components is erroneously detected by the corresponding sensor.

The plurality of the electromagnetic components may include: (i) a red portion; (ii) a green portion; (iii) a blue portion; and (iv) an ultraviolet portion.

The corresponding sensor may include: (i) a first sensor adapted to measure the red portion; (ii) a second sensor adapted to measure the green portion; and (iii) a third sensor adapted to measure the blue portion.

The first sensor, the second sensor, and the third sensor may be positioned along a focal plane of the lens.

A positioning of the first sensor along the focal plane of the lens may be based on a focal point of the red portion.

The corresponding absorber may be adapted to absorb the ultraviolet portion.

The lens may be adapted to prevent at least a portion of the one of the plurality of the electromagnetic components from passing through the lens.

In an embodiment, a method for managing leaks in a chassis of a data processing system is provided.

In an embodiment, a non-transitory media is provided that may include instructions that when executed by a processor cause the computer-implemented method to be performed.

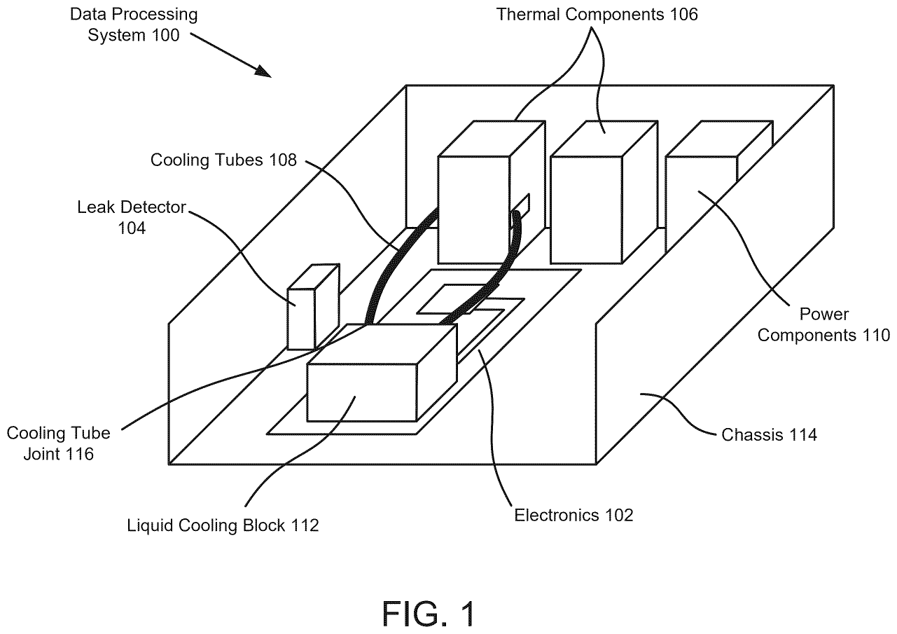

Turning to FIG. 1, a block diagram illustrating a system in accordance with an embodiment is shown. The system shown in FIG. 1 may provide any quantity and type of computer-implemented services. To provide the computer-implemented services, the system of FIG. 1 may include data processing system 100.

Data processing system 100 may include functionality to provide various types of computer-implemented services. The computer-implemented services may include any number and type of computer-implemented services. The computer-implemented services may include, for example, database services, data processing services, electronic communication services, and/or any other services that may be provided using one or more computing devices. Other types of computer-implemented services may be provided by data processing system 100 without departing from embodiments disclosed herein.

To provide the computer implemented services, data processing systems may include any number of hardware components. For example, operation of the any number of hardware components may facilitate various functionalities of data processing system 100, thereby allowing data processing system 100 to provide the computer-implemented services. The hardware components of data processing system 100 may include, for example, electronics 102, power components 110, and/or thermal components 106. Each of these is discussed below.

Electronics 102 may include at least a portion of the any number of hardware components, and as noted above, may provide computer-implemented services. Hardware components of electronics 102 may be positioned on circuit cards and may generate heat while operating. Circuit cards may be pieces of circuit boards.

Electronics 102 and/or any other components of the any number of hardware components of data processing system 100 may be positioned in chassis 114. Chassis 114 may include an enclosure in which physical structures of electronics 102 (e.g., processors, memory, etc.), and/or other components of data processing system 100 may be positioned. For example, chassis 114 may facilitate placement and management of electronics 102 and/or other components (e.g., power components 110 and/or thermal components 106) in a computing environment such as those discussed below.

Power components 110 may power the any number of hardware components of data processing system 100. For example, power components 110 may be implemented using power supplies. Furthermore, operation of these power supplies may also contribute to the generation of heat. If left unregulated, this generation of heat may increase the likelihood of damage to data processing system 100.

To manage the heat generated by the various components, data processing system 100 may include a liquid cooling system that is at least partially housed by chassis 114. This liquid cooling system may include any number of cooling components such as thermal components 106, cooling tubes 108, liquid cooling block 112, and/or any other cooling components not shown in the system of FIG. 1.

Thermal components 106 may thermally manage any of the components of data processing system 100. For example, thermal components 106 may include thermal components such as cooling fans, coolant reservoirs and/or receiving elements for coolant, coolant (e.g., a cooling fluid), circulation pumps, manifolds or other types of flow control components, and/or other components to facilitate performance of liquid-based cooling of at least some of electronics 102. For example, thermal components 106 may be used with cooling tubes 108 and liquid cooling block 112, each of which is discussed below.

Liquid cooling block 112 may facilitate a dissipation of heat generated by, for example, electronics 102 by circulating the cooling fluid via cooling tubes 108. To provide its functionality, liquid cooling block 112 may operate as a heat sink for some electronic components (e.g., a portion of electronics 102). For example, liquid cooling block 112 may be placed with an electronic component to: (i) receive heat generated by the electronic component, and (ii) dissipate the received heat into cooling fluid circulated through liquid cooling block 112. While providing its functionality, a transference of at least a portion of the generated heat may be facilitated.

For example, the cooling fluid may be confined to a flow path that circulates through a loop of a liquid cooling system (e.g., cooling tubes 108, liquid cooling block 112, external components such as large-scale coolant chillers, flow controllers, etc.). The flow path may be placed in thermal communication with a hardware component of electronics 102, which may be generating the heat when the cooling fluid is flowing through a portion of the loop that is proximate to the hardware component. By being in this thermal communication, the cooling fluid may be heated while the heat generated by the hardware component is dissipated into the cooling fluid, thereby regulating the temperature of the hardware component.

The heated cooling fluid circulating through liquid cooling block 112 may then flow to another portion of the loop (e.g., external to data processing system 100, such as a large-scale chiller, not shown) in order to be cooled. Thus, the cooling fluid may be cyclically heated and cooled as the cooling fluid continues to flow through the loop, thereby contributing to the dissipation of heat generated by the any number of hardware components of electronics 102.

For example, the cooling liquid may be directed through an interior of liquid cooling block 112 and through a first portion of cooling tubes 108. Cooling tubes 108 may further facilitate the circulation by directing the cooling liquid, for example, to other cooling blocks proximate to other hardware components of electronics 102. In doing so, cooling of multiple hardware components of electronics 102 may be facilitated. To do so, cooling tubes 108 may include hollow, tubular structures in which liquid may flow through. For example, the cooling liquid, once cooled by external chillers, may then be further circulated through a second portion of cooling tubes 108 to direct the cooling liquid back through the liquid cooling block 112 to facilitate transference of additional heat generated by electronics 102.

However, by using the liquid cooling system discussed above, a likelihood of physically damaging the any number of hardware components (e.g., should a leak in liquid cooling block 112 and/or cooling tubes 108 occur) may be increased due to the presence of the cooling liquid. For example, if liquid cooling block 112 and/or cooling tubes 108 begin to leak, at least a portion of the cooling liquid may no longer be confined to the flow path that circulates through the loop of the liquid cooling system.

Consequently, should the any number of hardware components become exposed to liquid (e.g., the cooling liquid), functionality of the any number of hardware components may be negatively impacted, thereby negatively impacting an ability of data processing system 100 to provide the computer-implemented services.

In general, embodiments disclosed herein may provide methods, systems, and/or devices for managing leaks in a chassis of a data processing system to improve a likelihood that the data processing system is able to provide its computer-implemented services. To improve the likelihood that data processing system 100 is able to provide its computer-implemented services, data processing system 100 may include functionality to detect leaks using a leak detector (e.g., leak detector 104).

Leak detector 104 may be positioned internal to data processing system 100 and may be used to monitor portions of data processing system 100 in which leaks may occur (e.g., portions of data processing system 100 in which leaks are more likely to occur compared to other portions of data processing system 100). For example, leaks of the cooling liquid may occur at connection points of cooling tubes 108, such as cooling tube joint 116. Cooling tube joint 116 may include any type of connector and/or fitting used to connect a portion of cooling tube 108 to liquid cooling block 112. During operation of the liquid-cooling system over time, cooling tube joint 116 may fail to maintain a seal between the portion of cooling tube 108 and liquid cooling block 112. For example, cooling tube joint 116 may fail due to corrosion, wear and tear, improper installation, damage, and/or other reasons. As a result, the cooling liquid may begin to leak.

To detect the leak, therefore limiting damage to various components of data processing system 100 due to contact with the cooling liquid, leak detector 104 may include: (i) an electromagnetic stimulator adapted to illuminate a sample area (e.g., in which the leak may occur) with electromagnetic radiation, (ii) an electromagnetic detector, and/or (iii) a management component. The electromagnetic detector may be adapted to divide at least a portion of the electromagnetic radiation into a plurality of electromagnetic components (e.g., based on wavelengths of the electromagnetic components) using a lens. The lens may be adapted to cause the division of the electromagnetic radiation due to a lateral chromatic aberration of the lens.

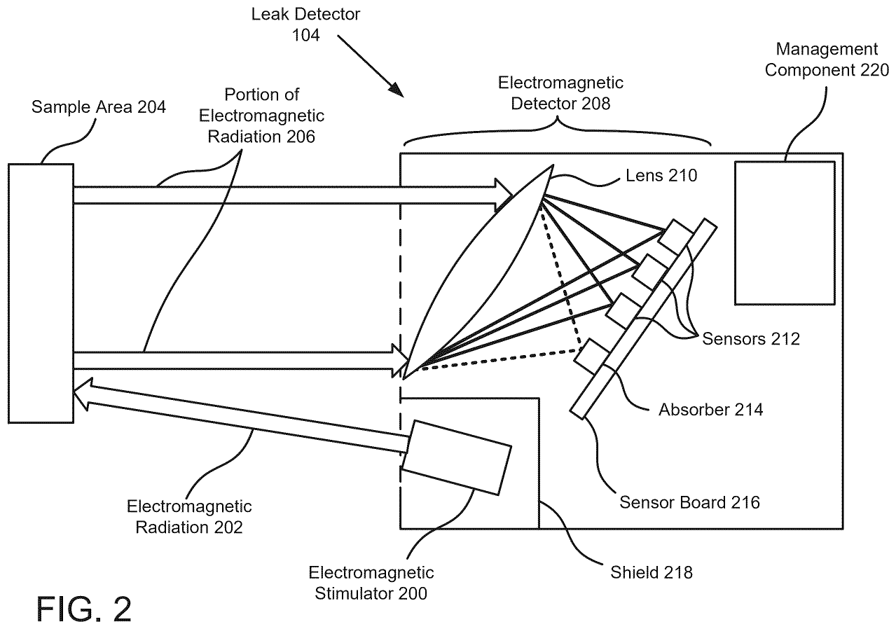

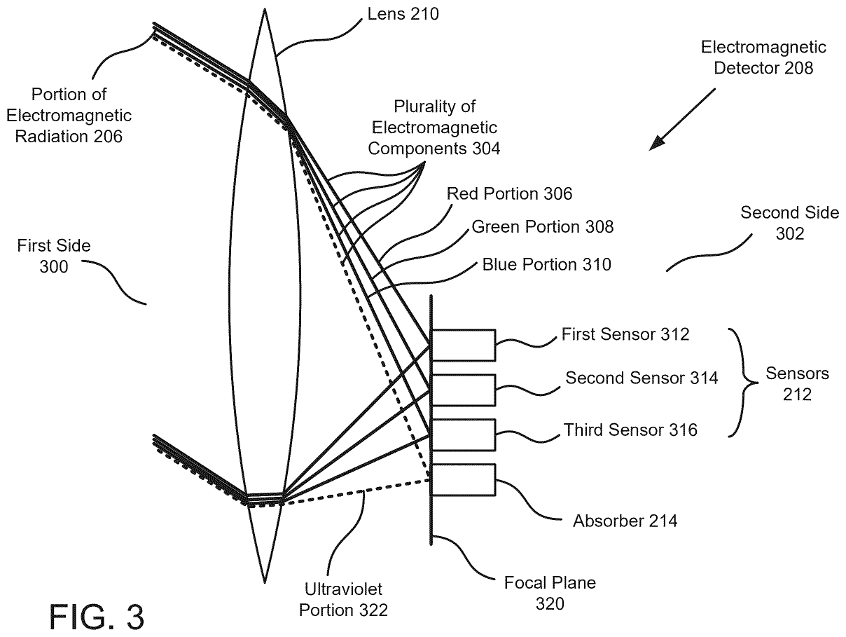

Each of the plurality of the electromagnetic components may be directed to a corresponding sensor (e.g., portions of the plurality of the electromagnetic components which are to be measured) or a corresponding absorber (e.g., portions of the plurality of the electromagnetic components which are not to be measured). In doing so, a plurality of electromagnetic measurements usable to estimate an electromagnetic spectrum for the sample area may be obtained. Based on the electromagnetic spectrum, the management component may determine whether the liquid leak occurred. If the liquid leak occurred, performance of a remediation action may be initiated to mitigate impacts of the liquid leak. For additional details regarding leak detector 104, refer to the description of FIGS. 2-3.

By doing so, embodiments disclosed herein may improve a likelihood that the data processing system is able to provide computer-implemented services by increasing a likelihood of detecting a leak in the chassis of the data processing system. As a result, additional leaked cooling liquid may be prevented from escaping into an interior of the chassis. In doing so, the likelihood of negatively impacting the hardware components, their functionalities, and the computer-implemented services that depend on these functionalities, may be reduced. Furthermore, detection of the leak may allow for remediation actions to be performed so that fluid communication may be successfully reestablished based on successful repair of the leak, thus allowing the computer-implemented services to be provided.

While illustrated in FIG. 1 with a limited number of specific components, a data processing system may include additional, fewer, and/or different components without departing from embodiments disclosed herein.

Turning to FIG. 2, a diagram illustrating leak detection in a chassis of a data processing system (e.g., data processing system 100) using leak detector 104 in accordance with an embodiment is shown. To detect the leak, leak detector 104 may include electromagnetic stimulator 200, electromagnetic detector 208, and management component 220. Each of these components is discussed below.

Electromagnetic stimulator 200 may be adapted to illuminate (e.g., irradiate) a sample area (e.g., sample area 204) with electromagnetic radiation 202. Sample area 204 may include a portion within the chassis which may have a risk of an occurrence of a liquid leak. For example, sample area 204 may include a liquid cooling tube joint and/or any other portion of the chassis for which leak detection is desired. In an instance of the occurrence of the liquid leak, sample area 204 may include at least a portion of the liquid leak, such as droplets, particles, and/or any other portion of the liquid leak (e.g., the sample).

Electromagnetic stimulator 200 may include any number and/or type of electromagnetic radiation sources adapted to generate electromagnetic radiation 202 (e.g., light) of any wavelength and/or intensity. For example, electromagnetic stimulator 200 may include an ultraviolet (UV) light emitting diode (LED) lamp, and/or any other type of lamp.

The properties of electromagnetic radiation 202 (e.g., wavelength, intensity, etc.) may be selected based on characteristics of the sample within sample area 204 to be detected (e.g., the portion of the liquid leak). For example, the selected wavelength of electromagnetic radiation 202 generated by electromagnetic stimulator 200 may interact with the sample in a desired manner. The interaction with the sample (e.g., excitation of electrons within the sample caused by absorbing a portion of electromagnetic radiation 202) may cause the sample to fluoresce.

Leak detector 104 may include shield 218 to reduce an amount of leakage of electromagnetic radiation 202 generated by electromagnetic stimulator 200 into electromagnetic detector 208. For example, electromagnetic stimulator 200 may be positioned within an interior of a same physical component as electromagnetic detector 208. Shield 218 may be a physical divider of any size or shape within the physical component adapted to absorb electromagnetic radiation 202. It will be appreciated that electromagnetic stimulator 200 may be located in a different physical component than electromagnetic detector 208 without departing from embodiments disclosed herein.

Upon illuminating sample area 204 with electromagnetic radiation 202, electromagnetic detector 208 may receive portion of electromagnetic radiation 206. Portion of electromagnetic radiation 206 may include: (i) any electromagnetic radiation generated by the sample in response to the illumination (e.g., sample generated fluorescence), and/or (ii) a portion of electromagnetic radiation 202 which may not have interacted with the sample (e.g., the portion of electromagnetic radiation may be received by electromagnetic detector 208 due to scattering and/or electromagnetic radiation leakage from electromagnetic stimulator 200).

Electromagnetic detector 208 may be adapted to: (i) divide portion of electromagnetic radiation 206 into a plurality of electromagnetic components, (ii) direct each of the plurality of the electromagnetic components to a corresponding sensor (e.g., one of sensors 212) or a corresponding absorber (e.g., absorber 214) to obtain a plurality of electromagnetic measurements, and/or (iii) estimate an electromagnetic spectrum based on the plurality of the electromagnetic measurements. To do so, electromagnetic detector 208 may include: (i) lens 210, (ii) sensors 212, (iii) absorber 214, and/or (iv) sensor board 216. Each of these components is discussed below.

Lens 210 may include any type and/or quantity of lenses of any size and/or shape. Lens 210 may be adapted to divide portion of electromagnetic radiation 206 into the plurality of electromagnetic components (e.g., based on colors/wavelengths of the electromagnetic components). Lens 210 may divide portion of electromagnetic radiation 206 due to a lateral chromatic aberration of lens 210. For example, to generate the lateral chromatic aberration, lens 210 may be positioned at an angle with respect to portion of electromagnetic radiation 206. The angle of lens 210 may be adapted to allow for the division of portion of electromagnetic radiation 206 and may result in each of the plurality of the electromagnetic components to be directed as desired. Refer to the description of FIG. 3 for additional details regarding lens 210 and/or the plurality of the electromagnetic components.

While described with respect to lens 210 dividing portion of electromagnetic radiation 206 due to a lateral chromatic aberration of lens 210, it will be appreciated that other methods may also be used to divide portion of electromagnetic radiation 206 using lens 210 without departing from embodiments disclosed here. For example, lens 210 may divide portion of electromagnetic radiation 206 due to longitudinal chromatic aberration.

While shown in FIG. 2 as lens 210 being positioned at a particular angle, it will be appreciated that lens 210 may be positioned at any angle to cause the division of portion of electromagnetic radiation 206 without departing from embodiments disclosed herein.

Each of the plurality of the electromagnetic components may be directed by lens 210 to one of sensors 212 or absorber 214. Sensors 212 may include any number and/or type of sensors adapted to make a plurality of electromagnetic measurements using portion of electromagnetic radiation 206. For example, a first sensor of sensors 212 may measure an intensity of a first electromagnetic components, and a second sensor of sensors 212 may measure an intensity of a second electromagnetic component. In doing so, the plurality of electromagnetic measurements may be made by sensors 212. Refer to the description of FIG. 3 for additional details regarding sensors 212.

Based on the plurality of electromagnetic measurements, an electromagnetic spectrum may be estimated. The electromagnetic spectrum may include, for example, spectral features based on each of the electromagnetic components measured by each of sensors 212. For example, the spectral features may include a measured intensity for a color (e.g., wavelength and/or range of wavelengths) of each of the electromagnetic components.

Absorber 214 may include any number and/or type of absorbers adapted to absorb one of the plurality of the electromagnetic components. For example, absorber 214 may be selected to absorb one of the plurality of electromagnetic components that is not intended to be measured, such as scattered and/or leaked electromagnetic radiation 202 (e.g., based on a wavelength and/or range of wavelengths of the one of the plurality of the electromagnetic components that is not intended to be measured). Doing so may improve an ability of electromagnetic detector 208 to detect a liquid leak.

For example, an ability of electromagnetic detector 208 to estimate the electromagnetic spectrum may be reduced when the one of the plurality of electromagnetic components is erroneously detected by a sensor of sensors 212. The one of the plurality of electromagnetic components may be erroneously detected due to scattering of the one of the plurality of the electromagnetic components within the physical component of leak detector 104. This negative impact may be due to an overlap in wavelengths of the electromagnetic components that are to be measured (e.g., generated by the leak) and the electromagnetic component that is not intended to be measured. As a result of including absorber 214 in electromagnetic detector 208, a likelihood of the one of the plurality of the electromagnetic components being erroneously detected by any of sensors 212 may be reduced.

For example, electromagnetic radiation 202 may include UV light. The UV light may illuminate sample area 204, which may include leak particles. The leak particles may fluoresce upon illumination, and the fluorescence may include visible light (e.g., electromagnetic radiation) of varying wavelengths. Portion of electromagnetic radiation 206 may be received by electromagnetic detector 208, which may include scattered UV light and the visible light generated by the leak particles. To determine whether the leak particles are present, the visible light portion of portion of electromagnetic radiation 206 may be divided by lens 210 based on wavelength and directed to sensors 212. The UV light portion may be divided from the visible light portion and directed to absorber 214.

To further reduce a likelihood that one of the plurality of the electromagnetic components is erroneously detected by any of sensors 212, lens 210 may be adapted to prevent at least a portion of the one of the plurality of the electromagnetic components from passing through lens 210 (e.g., due to material properties of lens 210). Continuing with the above example, UV light may not be intended to be measured by sensors 212. Lens 210 may be a polycarbonate lens, and as a result, may prevent a portion of the undesired UV light from passing through lens 210.

Sensors 212 and absorber 214 may be positioned within electromagnetic detector 208 using sensor board 216. Sensor board 216 may include any type of printed circuit board (e.g., flex, semi-flex) usable to provide a physical base for mounting and operably connecting sensors 212 and absorber 214.

For example, sensor board 216 may allow sensors 212 and absorber 214 to be operably connected to management component 220. Management component 220 may be adapted to determine whether a liquid leak within the chassis has occurred based on the electromagnetic spectrum. Management component 220 may include any type and/or quantity of components, such as a processing unit, that: (i) controls and/or monitors sensors 212, (ii) obtains information regarding a status of sensors 212, (iii) analyzes data obtained by sensors 212, and/or (iv) otherwise manages sensors 212.

Management component 220 may make the determination regarding whether the liquid leak occurred by analyzing the electromagnetic spectrum. Analyzing the electromagnetic spectrum may include comparing the electromagnetic spectrum to a known electromagnetic spectrum of the liquid. For example, a cooling liquid may have a known electromagnetic spectrum when illuminated with electromagnetic radiation 202. If the electromagnetic spectrum obtained based on the plurality of measurements made by sensors 212 matches the known electromagnetic spectrum for the cooling liquid, management component 220 may determine that the liquid leak has occurred. If the electromagnetic spectrum obtained based on the plurality of measurements made by sensors 212 does not match the known electromagnetic spectrum for the cooling liquid, management component 220 may determine that the liquid leak has not occurred.

If management component 220 determines that the liquid leak has occurred, management component 220 may initiate performance of a remediation action to mitigate impacts of the liquid leak. For example, management component 220 may: (i) notify a user of the data processing system via a graphical user interface that the liquid leak has occurred, (ii) generate an auditory notification indicating that the liquid leak has occurred, (iii) power off a portion of the hardware components of the data processing system (e.g., fans may be powered off to reduce spreading of the leak), and/or (iv) initiate performance of other remediation actions.

Turning to FIG. 3, a diagram illustrating an electromagnetic detector (e.g., electromagnetic detector 208) in accordance with an embodiment is shown. The electromagnetic detector may be a part of leak detector 104 used to manage leaks in a chassis of a data processing system (e.g., data processing system 100 shown in FIG. 1).

To manage the leaks, as discussed above, electromagnetic detector 208 may include lens 210. Lens 210 may be adapted to divide portion of electromagnetic radiation 206 to obtain plurality of electromagnetic components 304. Refer to the description of FIG. 2 for additional details regarding portion of electromagnetic radiation 206.

Lens 210 may include: (i) first side 300 through which portion of electromagnetic radiation 206 enters lens 210, and (ii) second side 302 through which plurality of electromagnetic components 304 exits lens 210. First side 300 may include a portion of lens 210 positioned facing towards portion of electromagnetic radiation 206. Lens 210 may be positioned at an angle with respect to portion of electromagnetic radiation 206. Thus, as portion of electromagnetic radiation 206 traverses lens 210, portion of electromagnetic radiation 206 may divide due to a lateral chromatic aberration of lens 210. The lateral chromatic aberration may cause different colors (e.g., wavelengths) of portion of electromagnetic radiation 206 to refract differently, resulting in a division of portion of electromagnetic radiation 206 into plurality of electromagnetic components 304 based on wavelengths of plurality of electromagnetic components 304.

While shown as portion of electromagnetic radiation 206 entering lens 210 at certain points on first side 300, it will be appreciated that portion of electromagnetic radiation 206 may enter lens 210 at any point along first side 300 without departing from embodiments disclosed herein.

Plurality of electromagnetic components 304 may exit second side 302 of lens 210. Second side 302 may be positioned facing away from a direction of portion of electromagnetic radiation 206, and sensors 212 and absorber 214 may be positioned with respect to second side 302. Each of sensors 212 and absorber 214 may be positioned with respect to lens 210 in a manner which allows each component of plurality of electromagnetic components 304 to be directed to a corresponding sensor (e.g., a sensor of sensors 212) or a corresponding absorber (e.g., absorber 214).

For example, plurality of electromagnetic components 304 may include: (i) red portion 306, (ii) green portion 308, (iii) blue portion 310, and/or (iv) ultraviolet (UV) portion 322. Each of the portions may include a range of wavelengths of electromagnetic radiation. For example, red portion 306 may include wavelengths of 620-750 nanometers (nm), etc. Each portion may be directed towards a corresponding sensor or corresponding absorber due to the lateral chromatic aberration of lens 210.

Sensors 212 may include first sensor 312, second sensor 314, and third sensor 316 (and/or any number of other sensors not shown). First sensor 312 may be adapted to measure red portion 306, second sensor 314 may be adapted to measure green portion 308, and third sensor 316 may be adapted to measure blue portion 310.

First sensor 312, second sensor 314, and third sensor 316 may be positioned along focal plane 320. Focal plane 320 may be a plane perpendicular to an optical axis of lens 210, and a focal point of each of plurality of electromagnetic components 304 may be positioned along focal plane 320. Each of the sensors may be positioned at the focal point of the electromagnetic component corresponding to the sensor. For example, a positioning of first sensor 312 along focal plane 320 may be based on the focal point of red portion 306. By doing so, each sensor may be positioned to detect a corresponding electromagnetic component of electromagnetic components 304.

Similarly, absorber 214 may be positioned along focal plane 320. A positioning of absorber 214 along focal plane 320 may be based on a focal point of an electromagnetic component of electromagnetic components 304 which is not intended to be measured by sensors 212. For example, absorber 214 may be adapted to absorb UV portion 322. UV portion 322 may be divided from other electromagnetic components 304 (e.g., red portion 306, green portion 308, blue portion 310) due to a difference in wavelength. For example, UV portion 322 may have a wavelength that is shorter than wavelengths of red portion 306, green portion 308, and blue portion 310. Due to the shorter wavelength, a focal point of UV portion 322 may be different from the focal points of the other portions (e.g., due to the lateral chromatic aberration of lens 210). Thus, absorber 214 may be placed at the focal point of UV portion 322, and may absorb UV portion 322 to reduce a likelihood that UV portion 322 is erroneously detected by any of sensors 212.

While described with respect to the electromagnetic detector including a single absorber, it will be appreciated that any number of absorbers may be included in the electromagnetic detector adapted to absorb different and/or the same electromagnetic components without departing from embodiments disclosed herein.

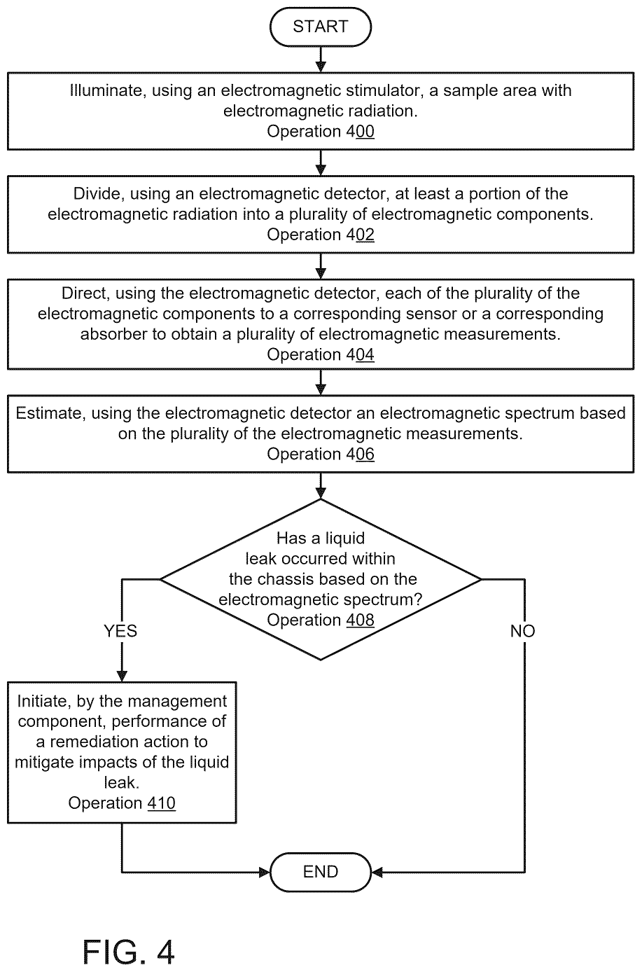

As discussed above, the components of FIGS. 1-3 may perform various methods to manage leaks in a chassis of a data processing system. FIG. 4 illustrates a method that may be performed by the components of the system of FIGS. 1-3. In the diagram discussed below and shown in FIG. 4, any of the operations may be repeated, performed in different orders, and/or performed in parallel with or in a partially overlapping in a timely manner with other operations. The method described with respect to FIG. 4 may be performed by a data processing system, any component of a data processing system, and/or another device.

Turning to FIG. 4, a flow diagram illustrating a method in accordance with an embodiment is shown. The flow diagram may illustrate various operations performed while managing leaks in a chassis of a data processing system. The data processing system may be similar to the data processing system discussed with respect to FIGS. 1-3.

At operation 400, a sample area may be illuminated with electromagnetic radiation using an electromagnetic stimulator. Illuminating the sample area may include: (i) generating the electromagnetic radiation by the electromagnetic stimulator, (ii) directing the electromagnetic radiation towards the sample area (e.g., by positioning the electromagnetic stimulator with respect to the sample area to allow for illumination of the sample area), and/or (iii) other methods.

At operation 402, at least a portion of the electromagnetic radiation may be divided into a plurality of electromagnetic components using an electromagnetic detector. Dividing the at least the portion of the electromagnetic radiation may include: (i) receiving the at least the portion of the electromagnetic radiation by the electromagnetic detector, (ii) segregating the at least the portion of the electromagnetic radiation into the plurality of the electromagnetic components using a lens, and/or (iii) other methods.

Segregating the at least the portion of the electromagnetic radiation into the plurality of the electromagnetic components using the lens may include: (i) positioning the lens at an angle with respect to a direction of travel of the at least the portion of the electromagnetic radiation, the angle allowing for a lateral chromatic aberration of the lens, (ii) refracting the at least the portion of the electromagnetic radiation based on wavelength, resulting in separation of the at least the portion of the electromagnetic radiation into the plurality of the electromagnetic components, and/or (iii) other methods.

At operation 404, each of the plurality of the electromagnetic components may be directed to a corresponding sensor or a corresponding absorber using the electromagnetic detector to obtain a plurality of electromagnetic measurements. Directing each of the plurality of the electromagnetic components may include: (i) positioning the corresponding sensor or the corresponding absorber at a focal point of one of the plurality of the electromagnetic components, (ii) focusing the one of the plurality of the electromagnetic components by the lens to the focal point, (iii) collecting an electromagnetic measurement by the corresponding sensors for each of the plurality of the electromagnetic components to obtain the plurality of the electromagnetic measurements, and/or (iv) other methods.

At operation 406, an electromagnetic spectrum may be estimated based on the plurality of the electromagnetic measurements using the electromagnetic detector. Estimating the electromagnetic spectrum may include: (i) analyzing the plurality of the electromagnetic measurements (e.g., individually by sensor and/or in aggregate) by the electromagnetic detector to obtain the electromagnetic spectrum, (ii) providing the plurality of electromagnetic measurements to another component of the data processing system and/or other entity responsible for estimating the electromagnetic spectrum, and/or (iii) other methods.

At operation 408, a determination may be made by a management component regarding whether a liquid leak within the chassis has occurred based on the electromagnetic spectrum. Making the determination may include: (i) obtaining, by the management component, the electromagnetic spectrum of the sample area, (ii) comparing the electromagnetic spectrum of the sample area to a known electromagnetic spectrum for the liquid to obtain a result, (iii) providing the electromagnetic spectrum to another entity and receiving an indication of whether the liquid leak has occurred in response, and/or (iv) other methods.

For example, if the result indicates that the electromagnetic spectrum of the sample area matches the known electromagnetic spectrum for the liquid, the management component may determine that the liquid leak has occurred. In another example, if the result indicates that the electromagnetic spectrum of the sample area does not match the known electromagnetic spectrum for the liquid, the management component may determine that the liquid leak has not occurred.

If it is determined that the liquid leak has occurred within the chassis (e.g., the determination is “Yes” at operation 408), then the method may proceed to operation 410.

At operation 410, the management component may initiate performance of a remediation action to mitigate impacts of the liquid leak. Initiating performance of the remediation action may include: (i) notifying a user of the data processing system via a graphical user interface that the liquid leak has occurred, (ii) powering a speaker to generate an auditory notification indicating that the liquid leak has occurred, (iii) powering off a portion of the hardware components of the data processing system (e.g., fans may be powered off to reduce spreading of the leak, electrical components may be powered off to reduce damage), and/or (iv) other methods.

The method may end following operation 410.

Returning to operation 408, if it is determined that the liquid leak has not occurred within the chassis (e.g., the determination is “No” at operation 408), then the method may end. The data processing system may continue to provide computer-implemented services as desired.

Thus, embodiments disclosed herein may address, among others, the technical challenge of mitigating risks associated with using a cooling liquid to provide thermal management services for a data processing system. To do so, the data processing system may include a leak detector, which may be adapted to divide electromagnetic radiation into a plurality of electromagnetic components using a lens. The lens may divide the at least the portion the electromagnetic radiation due to a lateral chromatic aberration.

In doing so, a portion of the electromagnetic components may be measured by sensors, and a portion may be absorbed (e.g., not measured). As a result, an electromagnetic spectrum may be obtained using the leak detector which is usable to determine whether the liquid leak has occurred. If the liquid leak has occurred, a remediation action may be performed. Thus, a likelihood of a liquid leak negatively impacting hardware functionality may be decreased and may in turn decrease a likelihood of negatively impacting computer-implemented services provided by the data processing system.

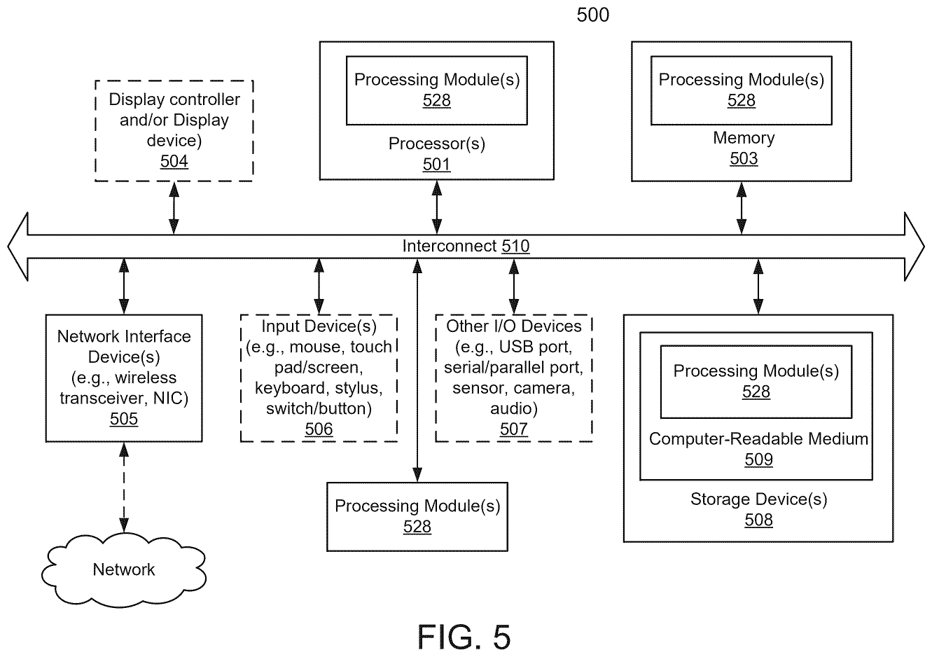

Any of the components and methods illustrated in FIGS. 1-4 may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A data processing system, comprising:
a chassis;
an electromagnetic stimulator adapted to illuminate a sample area with electromagnetic radiation;
an electromagnetic detector adapted to:
divide at least a portion of the electromagnetic radiation into a plurality of electromagnetic components,
direct each of the plurality of the electromagnetic components to a corresponding sensor or a corresponding absorber to obtain a plurality of electromagnetic measurements,
estimate an electromagnetic spectrum based on the plurality of the electromagnetic measurements; and
a management component adapted to:
make a determination regarding whether a liquid leak within the chassis has occurred based on the electromagnetic spectrum; and
in an instance of the determination where the liquid leak has occurred:
initiate performance of a remediation action to mitigate impacts of the liquid leak.

2. The data processing system of claim 1, wherein the electromagnetic detector comprises:
a lens adapted to divide the at least the portion of the electromagnetic radiation to obtain the plurality of the electromagnetic components;
the corresponding sensor to make a first one of the plurality of the electromagnetic measurements; and
the corresponding absorber adapted to absorb a one of the plurality of the electromagnetic components to reduce a likelihood that the one of the plurality of the electromagnetic components is erroneously detected by the corresponding sensor while making the first one of the plurality of the electromagnetic measurements.

3. The data processing system of claim 2, wherein the lens comprises:
a first side through which the electromagnetic radiation enters the lens; and
a second side through which the plurality of the electromagnetic components exits the lens.

4. The data processing system of claim 3, wherein the corresponding sensor and the corresponding absorber are positioned with respect to the second side of the lens.

5. The data processing system of claim 2, wherein the lens divides the at least the portion of the electromagnetic radiation based on wavelengths of the plurality of the electromagnetic components.

6. The data processing system of claim 5, wherein the lens divides the at least the portion of the electromagnetic radiation due to a lateral chromatic aberration of the lens.

7. The data processing system of claim 6, wherein the lens is positioned at an angle with respect to the electromagnetic radiation to generate the lateral chromatic aberration.

8. The data processing system of claim 2, wherein an ability of the electromagnetic detector to estimate the electromagnetic spectrum is reduced when the one of the plurality of the electromagnetic components is erroneously detected by the corresponding sensor.

9. The data processing system of claim 2, wherein the plurality of the electromagnetic components comprises:
a red portion;
a green portion;
a blue portion; and
an ultraviolet portion.

10. The data processing system of claim 9, wherein the corresponding sensor comprises:
a first sensor adapted to measure the red portion;
a second sensor adapted to measure the green portion; and
a third sensor adapted to measure the blue portion.

11. The data processing system of claim 10, wherein the first sensor, the second sensor, and the third sensor are positioned along a focal plane of the lens.

12. The data processing system of claim 11, wherein a positioning of the first sensor along the focal plane of the lens is based on a focal point of the red portion.

13. The data processing system of claim 9, wherein the corresponding absorber is adapted to absorb the ultraviolet portion.

14. The data processing system of claim 2, wherein the lens is adapted to prevent at least a portion of the one of the plurality of the electromagnetic components from passing through the lens.

15. A method for managing leaks in a chassis of a data processing system, the method comprising:
illuminating, using an electromagnetic stimulator, a sample area with electromagnetic radiation;
dividing, using an electromagnetic detector, at least a portion of the electromagnetic radiation into a plurality of electromagnetic components,
directing, using the electromagnetic detector, each of the plurality of the electromagnetic components to a corresponding sensor or a corresponding absorber to obtain a plurality of electromagnetic measurements,
estimating, using the electromagnetic detector, an electromagnetic spectrum based on the plurality of the electromagnetic measurements;
making, by a management component, a determination regarding whether a liquid leak within the chassis has occurred based on the electromagnetic spectrum; and
in an instance of the determination where the liquid leak has occurred:
initiating, by the management component, performance of a remediation action to mitigate impacts of the liquid leak.

16. The method of claim 15, wherein the electromagnetic detector comprises:
a lens adapted to divide the at least the portion of the electromagnetic radiation to obtain the plurality of the electromagnetic components;
the corresponding sensor to make a first one of the plurality of the electromagnetic measurements; and
the corresponding absorber adapted to absorb a one of the plurality of the electromagnetic components to reduce a likelihood that the one of the plurality of the electromagnetic components is erroneously detected by the corresponding sensor while making the first one of the plurality of the electromagnetic measurements.

17. The method of claim 16, wherein the lens comprises:
a first side through which the electromagnetic radiation enters the lens; and
a second side through which the plurality of the electromagnetic components exits the lens.

18. A non-transitory machine-readable medium having instructions stored therein, which when executed by a processor, cause the processor to perform operations for managing leaks in a chassis of a data processing system, the operations comprising:
illuminating, using an electromagnetic stimulator, a sample area with electromagnetic radiation;
dividing, using an electromagnetic detector, at least a portion of the electromagnetic radiation into a plurality of electromagnetic components,
directing, using the electromagnetic detector, each of the plurality of the electromagnetic components to a corresponding sensor or a corresponding absorber to obtain a plurality of electromagnetic measurements,
estimating, using the electromagnetic detector, an electromagnetic spectrum based on the plurality of the electromagnetic measurements;
making, by a management component, a determination regarding whether a liquid leak within the chassis has occurred based on the electromagnetic spectrum; and
in an instance of the determination where the liquid leak has occurred:
initiating, by the management component, performance of a remediation action to mitigate impacts of the liquid leak.

19. The non-transitory machine-readable medium of claim 18, wherein the electromagnetic detector comprises:
a lens adapted to divide the at least the portion of the electromagnetic radiation to obtain the plurality of the electromagnetic components;
the corresponding sensor to make a first one of the plurality of the electromagnetic measurements; and
the corresponding absorber adapted to absorb a one of the plurality of the electromagnetic components to reduce a likelihood that the one of the plurality of the electromagnetic components is erroneously detected by the corresponding sensor while making the first one of the plurality of the electromagnetic measurements.

20. The non-transitory machine-readable medium of claim 19, wherein the lens comprises:
a first side through which the electromagnetic radiation enters the lens; and
a second side through which the plurality of the electromagnetic components exits the lens.
